(19) United States
(12) Patent Application Publication
(10) Pub. No.: US 2025/0229159 A1
(43) Pub. Date: Jul. 17, 2025

(54) SPORTS TRAINING SYSTEM WITH EMBODIED AND DETACHED AUGMENTED REALITY VISUALIZATION

(71) Applicant: Purdue Research Foundation, West Lafayette, IN (US)

(72) Inventors: Karthik Ramani, West Lafayette, IN (US); Dizhi Ma, West Lafayette, IN (US)

(21) Appl. No.: 19/026,911

(22) Filed: Jan. 17, 2025

Related U.S. Application Data
(60) Provisional application No. 63/621,800, filed on Jan. 17, 2024.

(51) Int. Cl. A63B 71/06; A63B 24/00; A63B 102/16; G06T 7/246; G06T 13/40; G06V 20/20; G06V 40/20

(52) U.S. Cl. CPC A63B 71/0622; A63B 24/0006; G06T 7/251; G06T 13/40; G06V 20/20; G06V 40/23; A63B 2024/0009; A63B 2071/0647; A63B 2071/0694; A63B 2102/16; A63B 2220/05; A63B 2220/34; A63B 2220/40; A63B 2220/806; G06T 2200/24; G06T 2207/10016; G06T 2207/30196; G06T 2207/30241

(57) ABSTRACT

A method for providing visual guidance for sports training is disclosed. The method advantageously captures and analyzes the real-time motions of a novice athlete and compares them with the previously recorded motions of an expert athlete. Additionally, the method advantageously provides both embodied and detached visual guidance for the novice athlete and, in particular, provides feedback that helps the novice athlete to quickly and intuitively understand the differences between their real-time motions and the previously recorded motions of the expert athlete.

This application claims the benefit of priority of U.S. provisional application Ser. No. 63/621,800, filed on Jan. 17, 2024 the disclosure of which is herein incorporated by reference in its entirety.

### GOVERNMENT LICENSE RIGHTS

This invention was made with government support under contract number DUE1839971 awarded by the National Science Foundation. The government has certain rights in the invention.

### FIELD

The device and method disclosed in this document relate to augmented reality and, more particularly, to a sports training system with embodied and detached augmented reality visualization.

### BACKGROUND

Unless otherwise indicated herein, the materials described in this section are not admitted to be the prior art by inclusion in this section.

The realm of table tennis techniques encompasses a wide array of elements, spanning from Technical Skills (grip, stroke, spin, and speed), tactical understanding (game analysis, serve and receive strategies, gameplay tactics, strategic shot placement), and physical and mental aspects (footwork, adaptability, quick decision making, mental toughness, physical conditioning). Stroke training can be considered the most fundamental for all players since it forms the basis for executing various shots effectively. Traditional table tennis stroke training involves coaches who demonstrate specific techniques, and players mimic the strokes and receive feedback and corrections from the coach. However, conventional coaching methods may face challenges in addressing trainees' self-awareness and perception, the ability to see and translate their own performance, skill acquisition through observation, coach availability, providing real-time feedback, addressing individual learning styles and pace, and accommodating diverse schedules, resources, and skill levels among trainees. These limitations underscore the necessity for new training methods that address these challenges and provide more personalized and accessible learning opportunities for players.

In the realm of coach-less training, prior research has delved into video-based approaches because of their convenience. Leveraging pose estimation algorithms to glean 2D or 3D body poses from videos, researchers have efficiently assessed novice athletes' performance compared with experts' and generated corresponding feedback. Although video-based analysis is a valuable supplement to training, it has limitations including the absence of real-time correction and the potential misinterpretation of techniques, thus hindering effective skill development.

Virtual reality (VR) and augmented reality (AR) technologies provide immersive and in-situ visualization that video-based methods cannot offer. Researchers have increasingly turned their focus towards harnessing these innovations for the creation of sports training systems across diverse disciplines. Noteworthy examples span a spectrum of sports and physical practices. Many elements, such as grip, stance, racket movement, contact point, and follow-through form key elements of stroke, posture, and movement. Proper posture provides a stable and balanced foundation for a stroke, and good footwork and movement enable a player to position themselves for each stroke. When it comes to posture or movement training, previous works demonstrate the target content in a similar fashion as the video-based methods by putting the visual cues “detached” from the user in a third-person view. Although it is useful to observe in a third-person view, mimicking skills through observing the detached cues might not be straightforward due to the lack of perspective as well as the pose, orientation, and cognitive transfer burden of relative elements of the entire body, compared to embodied visualization such as virtual cues overlaid on the physical body that can be provided by new AR-VR systems.

These groundbreaking initiatives within the realms of AR and VR underscore the growing recognition of their potential to offer intuitive feedback and elevate training experiences. In the context of table tennis training, extensive research has been conducted in the VR and AR domains. These investigations have delved into the efficacy of enhancing table tennis performance across various domains. Examples include VR simulations of gameplay, the provision of multi-modal cues within VR environments, and the visualization of ball trajectories on AR tables, among others. However, the aforementioned applications in the realm of table tennis training have yet to prioritize stroke training and provide visualization of paddle and body movements.

### SUMMARY

A method for providing visual guidance for sports training is described herein. The method includes storing, in a memory, previously recorded motions of a first person holding first hand-held sports equipment. The previously recorded motions include motions of a body of the first person and motions of the first hand-held sports equipment. The method further includes capturing, with at least one motion sensor, real-time motions of a second person holding second hand-held sports equipment. The second hand-held sports equipment is of a same type as the first hand-held sports equipment. The real-time motions include motions of a body of the second person and motions of the second hand-held sports equipment. The method further includes determining, with a processor, differences between the real-time motions of the second person and the previously recorded motions of the first person. The method further includes displaying, on a display of an augmented reality device, a visualization of at least one of (i) the previously recorded motions of the first person and (ii) the real-time motions of the second person. The visualization includes visual indications of the determined differences between the real-time motions of the second person and the previously recorded motions of the first person.

### BRIEF DESCRIPTION OF THE DRAWINGS

The foregoing aspects and other features of the system and method are explained in the following description, taken in connection with the accompanying drawings.

FIGS. 1A-1D summarize a workflow of an AR sports training system.

FIG. 2 shows exemplary components of the AR sports training system.

FIG. 3 shows a logical flow diagram for a method for providing visual guidance for sports training.

FIG. 4 shows exemplary AR graphical user interfaces of the AR sports training system.

FIG. 5 shows a motion capture process of the motion capture module.

FIG. 6 shows pseudocode for an Algorithm 1 that compares the body movements of the novice athlete and the body movements of the expert athlete.

FIG. 7 shows pseudocode for an Algorithm 2 that compares the movements of hand-held sports equipment held by the novice athlete and the movements of hand-held sports equipment held by the expert athlete.

FIG. 8A shows exemplary detached virtual avatars for table tennis sports training.

FIG. 8B shows exemplary embodied virtual avatars for table tennis sports training.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

### Overview

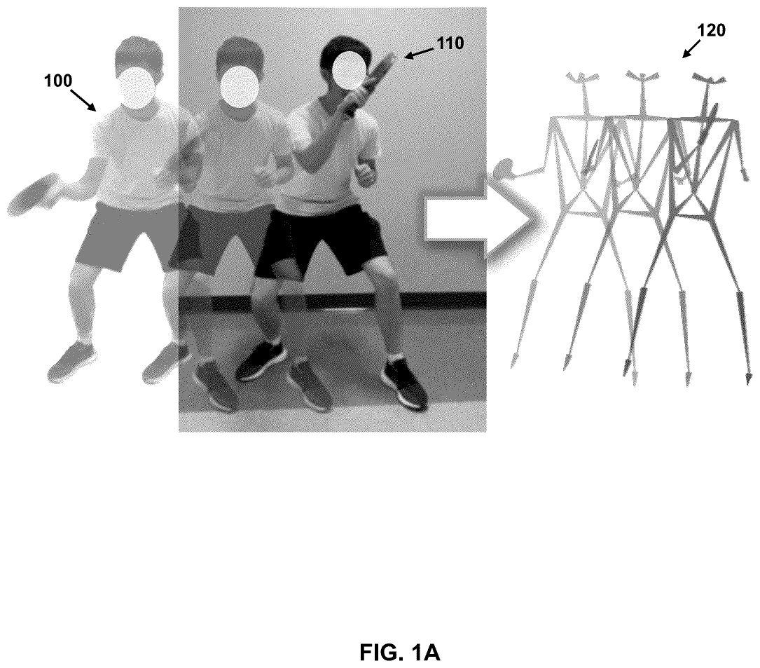

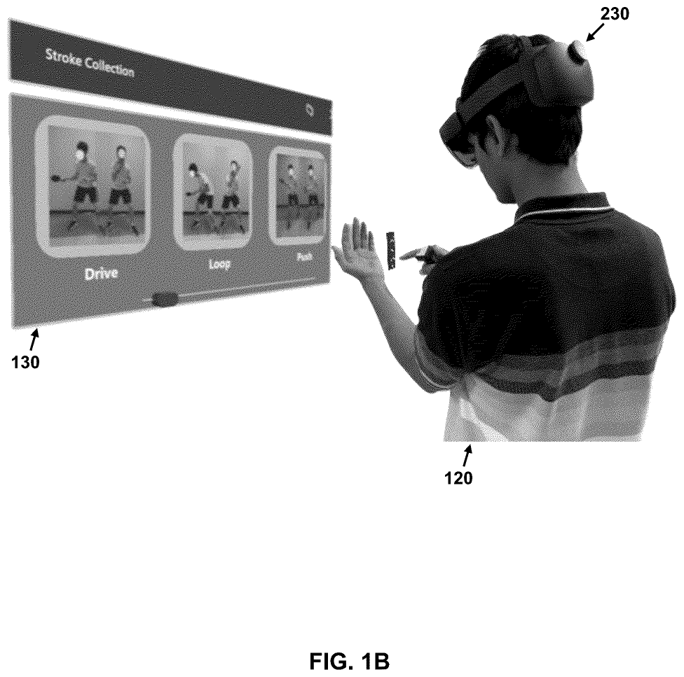

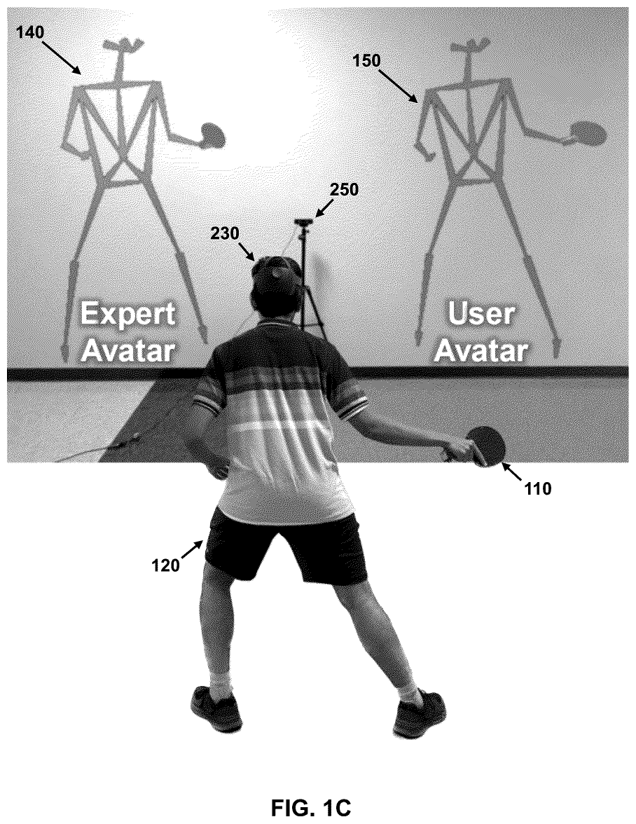

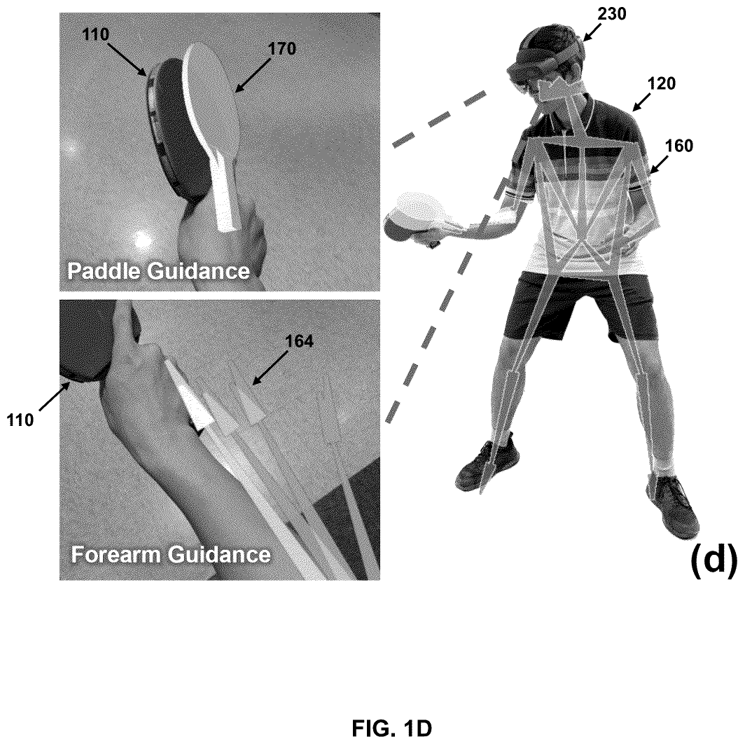

FIGS. 1A-1D summarize a workflow of an AR sports training system 200. The AR sports training system 200 is designed to enhance sports skills through embodied and detached visual cues. Throughout the disclosure and in the illustrations, the sports training system 200 is described and illustrated with respect to a system designed for table tennis stroke training. However, it should be appreciated that the AR sports training system 200 can be adapted to a wide variety of key motions and maneuvers in a wide variety of sports, such as traditional tennis, golf, baseball, and other sports utilizing rackets, paddles, clubs, or other hand-held sports equipment. As used herein “hand-held sports equipment” refers to any object that is held in a person's hand and maneuvered, such as by swinging, to play a sport, or similar game incorporating physical activity. Examples include, but are not limited to, paddles, rackets, mallets, clubs, bats, and sticks It should be appreciated, however, that the AR sports training system 200 may also support training for sports that lack such hand-held equipment, such as basketball, volleyball, or martial arts.

With reference to FIG. 1A, an expert athlete 100 records sports-related motions while holding corresponding hand-held sports equipment 110, and saves the recorded motions in memory of the AR sports training system 200. In the illustrated example, the expert athlete 100 records a variety of different table tennis strokes while holding a table tennis paddle. To these ends, the AR sports training system 200 employs a vision-based pose estimation algorithm and an IMU sensor to capture the 3D body pose of the user and the pose of the hand-held sports equipment 110. Using this visual-sensor solution, the AR sports training system 200 records the motions of the expert athlete 100 and stores them in a database. In some embodiments, the IMU sensor may be omitted and a vision-only pose estimation is utilized. The motions of the expert athlete 100 that are recorded by the AR sports training system 200 are stored in a memory of the AR sports training system 200.

With reference to FIG. 1B, the AR sports training system 200 provides an AR graphical user interface 130 via which a novice athlete 120 can select specific sports-related motions from a library of previously recorded motions of one or more expert athletes 100 for practicing. In the illustrated example, a novice athlete 120 selects from a library of different table tennis strokes a particular stroke that he or she would like to practice, for example, a ‘Drive’ stroke, a ‘Loop’ stroke, or a ‘Push’ stroke.

With reference to FIG. 1C, once the novice athlete 120 selects a motion from the library, the AR sports training system 200 begins capturing real-time motions of the novice athlete 120 as he or she practices performing the selected motion while holding the hand-held sports equipment 110. The AR sports training system 200 captures the real-time motions of the novice athlete 120 in the same manner as the motions of the expert athlete 100. Meanwhile, the AR sports training system 200 provides visual guidance to the novice athlete 120 that enables the novice athlete 120 to quickly assess their performance and correct discrepancies between their real-time motions and those of the expert athlete 100.

As the novice athlete 120 practices the selected motion, the AR sports training system 200 advantageously provides both embodied and detached visual guidance for the novice athlete 120 and, in particular, provides feedback that helps the novice athlete 120 to quickly and intuitively understand the differences between their real-time motions and the previously recorded motions of the expert athlete 100. In the context of table tennis, the AR sports training system 200 could be used in common table tennis training sessions such as shadow practice and multi-ball practice.

The AR graphical user interface 130 incorporates an expert avatar 140 holding virtual sports equipment that is animated to represent the previously recorded motions of the expert athlete 100. Similarly, the AR graphical user interface 130 incorporates a novice avatar 150 (also referred to as the user avatar) holding virtual sports equipment that is continuously animated to represent the real-time motions of the novice athlete 120. The expert avatar 140 and the novice avatar 150 are superimposed upon the environment of the novice athlete 120 within the AR graphical user interface 130, such that they appear in front of the novice athlete 120.

The AR sports training system 200 advantageously analyzes the real-time motions of the novice athlete 120 and compares them with the previously recorded motions of the expert athlete 100. Based on this analysis, the AR sports training system 200 advantageously renders the novice avatar 150 to incorporate visual indications of the differences between the real-time motions of the novice athlete 120 and the previously recorded motions of the expert athlete 100. In the illustrated example, specific portions of the novice avatar 150 (e.g., specific joints) are highlighted in a different color (e.g., pink) to indicate that the motions of corresponding portions of the body of the novice athlete 120 are incorrect (i.e., they differ from the motions that were recorded by the expert athlete 100).

With reference to FIG. 1D, concurrent with the detached visual guidance provided in the form of the expert avatar 140 and the novice avatar 150, the AR sports training system 200 also provides embodied visual guidance in the form of an embodied avatar 160 that is superimposed upon the body of the novice athlete 120. The embodied avatar 160 at least includes a virtual arm 164 holding virtual sports equipment 170, but may include a full-body virtual avatar similar to the expert avatar 140 and the novice avatar 150. The embodied virtual arm 164 is superimposed upon the arm of the novice athlete 120, and the virtual sports equipment 170 is superimposed upon the hand-held sports equipment 110. The embodied virtual arm 164 is animated to show arm trajectories corresponding to the previously recorded motions of the expert athlete 100. Likewise, the virtual sports equipment 170 is rendered to show the correct orientation of the hand-held sports equipment 110.

Table tennis stroke training is a critical aspect of player development. Traditional coaching methods face limitations in trainee self-awareness and perception, skill acquisition by third-person observation, and coach availability. Video-based methods, using pose estimation, have efficiently compared user performance with experts, but face real-time correction challenges and potential misinterpretations. Meanwhile, previous extended reality approaches also fail to provide a comprehensive visualization to help the player learn the movement of the body and paddle.

The AR sports training system 200 bridges these gaps by employing a combination of pose estimation algorithms and IMU sensors to capture and reconstruct the 3D body pose and paddle orientation of novice athletes during practice, allowing real-time comparison with expert strokes. This visual-sensor setup, combined with a motion analysis algorithm, effectively captures the user's body and paddle movements in 3D, enabling the reconstruction of their virtual avatar while providing feedback through detached and embodied visual cues for comprehensive pose and paddle analysis.

The AR sports training system 200 advantageously promotes immersive, embodied learning experiences by providing an AR graphical user interface that includes both detached and embodied visual cues, enabling novice athletes to visualize and correct their strokes effectively. The AR graphical user interface 130 is implemented to enable novice athletes to interact with visual cues in a personalized way, enhancing the overall training experience.

### Exemplary Hardware and Software Components

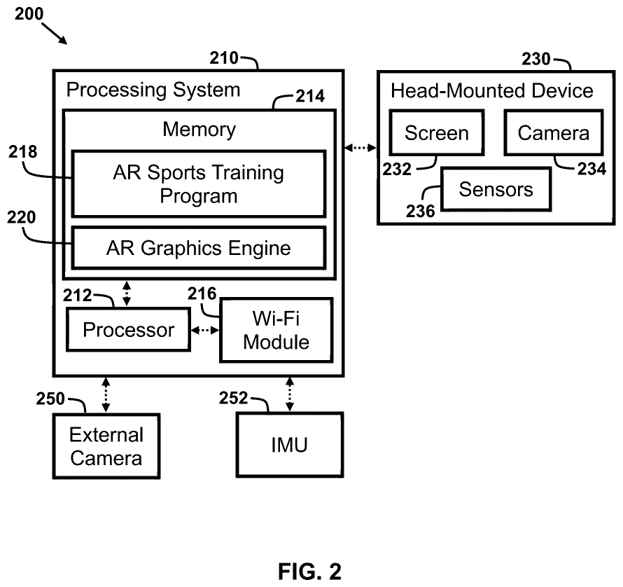

FIG. 2 shows exemplary components of the AR sports training system 200. It should be appreciated that the components of the AR sports training system 200 shown and described are merely exemplary and that the AR sports training system 200 may comprise any alternative configuration. Moreover, in the illustration of FIG. 2, only a single AR system is shown. However, in practice, the AR sports training system 200 may include one or multiple AR systems.

In the illustrated exemplary embodiment, the AR sports training system 200 includes a processing system 210 and the head-mounted AR device 230 (e.g., Microsoft's HoloLens, Oculus Rift, or Oculus Quest). However, it should be appreciated that, in some embodiments, a tablet computer or mobile phone can be used in place of the head-mounted AR device 230. Thus, similar AR graphical user interfaces and features would be provided on the tablet computer or mobile phone. In some embodiments, the processing system 210 may comprise a discrete computer that is configured to communicate with the head-mounted AR device 230 via one or more wired or wireless connections. However, in alternative embodiments, the processing system 210 is integrated with the head-mounted AR device 230. Additionally, the AR sports training system 200 includes external sensors including an external camera 250, an IMU 252 (inertial measurement unit), as well as any other external sensors used by the head-mounted AR device 230 (e.g., Oculus IR-LED Sensors).

In the illustrated exemplary embodiment, the processing system 210 comprises a processor 212 and a memory 214. The memory 214 is configured to store data and program instructions that, when executed by the processor 212, enable the AR sports training system 200 to perform various operations described herein. The memory 214 may be of any type of device capable of storing information accessible by the processor 212, such as a memory card, ROM, RAM, hard drives, discs, flash memory, or any of various other computer-readable medium serving as data storage devices, as will be recognized by those of ordinary skill in the art. Additionally, it will be recognized by those of ordinary skill in the art that a “processor” includes any hardware system, hardware mechanism, or hardware component that processes data, signals, or other information. The processor 212 may include a system with a central processing unit, graphics processing units, multiple processing units, dedicated circuitry for achieving functionality, programmable logic, or other processing systems.

The processing system 210 further comprises one or more transceivers, modems, or other communication devices configured to enable communications with various other devices, at least including the head-mounted AR device 230, the external camera 250, and the IMU 252. Particularly, in the illustrated embodiment, the processing system 210 comprises a Wi-Fi module 216. The Wi-Fi module 216 is configured to enable communication with a Wi-Fi network and/or Wi-Fi router (not shown) and includes at least one transceiver with a corresponding antenna, as well as any processors, memories, oscillators, or other hardware conventionally included in a Wi-Fi module. It will be appreciated, however, that other communication technologies, such as Bluetooth, Z-Wave, Zigbee, or any other radio frequency-based communication technology or wired communication technology can be used to enable data communications between devices in the AR sports training system 200.

The head-mounted AR device 230 is in the form of an AR or virtual reality (VR) headset, generally comprising a display screen 232 and a camera 234 (e.g., ZED Dual 4MP Camera (720p)). The camera 234 may be an integrated or attached camera and is configured to capture a plurality of images of the environment as the head-mounted AR device 230 is moved through the environment by the athlete. The camera 234 is configured to generate image frames of the environment, each of which comprises a two-dimensional array of pixels. Each pixel has corresponding photometric information (intensity, color, and/or brightness). In some embodiments, the camera 234 is configured to generate RGB-D images in which each pixel has corresponding photometric information and geometric information (depth and/or distance). In such embodiments, the camera 234 may, for example, take the form of two RGB cameras configured to capture stereoscopic images, from which depth and/or distance information can be derived, or an RGB camera with an associated IR camera configured to provide depth and/or distance information.

The display screen 232 may comprise any of various known types of displays, such as LCD or OLED screens. In at least one embodiment, the display screen 232 is a transparent screen, through which a user can view the outside world, on which certain graphical elements are superimposed onto the user's view of the outside world. In the case of a non-transparent display screen 232, the graphical elements may be superimposed on real-time images/video captured by the camera 234.

In some embodiments, the head-mounted AR device 230 may further comprise a variety of sensors 236. In some embodiments, the sensors 236 include sensors configured to measure one or more accelerations and/or rotational rates of the head-mounted AR device 230. In one embodiment, the sensors 236 comprise one or more accelerometers configured to measure linear accelerations of the head-mounted AR device 230 along one or more axes (e.g., roll, pitch, and yaw axes) and/or one or more gyroscopes configured to measure rotational rates of the head-mounted AR device 230 along one or more axes (e.g., roll, pitch, and yaw axes). In some embodiments, the sensors 236 may include inside-out motion tracking sensors configured to track the human body motion of the user within the environment, in particular positions and movements of the head and hands of the user.

The head-mounted AR device 230 may also include a battery or other power source (not shown) configured to power the various components within the head-mounted AR device 230, which may include the processing system 210, as mentioned above. In one embodiment, the battery of the head-mounted AR device 230 is a rechargeable battery configured to be charged when the head-mounted AR device 230 is connected to a battery charger configured for use with the head-mounted AR device 230.

The program instructions stored on the memory 214 include an AR sports training program 218. As discussed in further detail below, the processor 212 is configured to execute the AR sports training program 218 to provide detached and embodied AR visualizations and feedback for sports training. In one embodiment, the program instructions stored on the memory 214 further include an AR graphics engine 220 (e.g., Unity3D engine), which is used to render the intuitive visual interface of the AR sports training program 218. Particularly, the processor 212 is configured to execute the AR graphics engine 220 to superimpose on the display screen 232 graphical elements to provide detached and embodied AR visualizations and feedback for sports training. In the case of a non-transparent display screen 232, the graphical elements may be superimposed on real-time images/video captured by the camera 234.

The external camera 250 (e.g., a webcam) is arranged externally to the head-mounted AR device 230 at a location (e.g., in front of the user) suitable for capturing video of the user as he or she engages in sports training using the AR sports training system 200. The external camera 250 is configured to generate image frames of the environment including the user, each of which comprises a two-dimensional array of pixels. Each pixel has corresponding photometric information (intensity, color, and/or brightness). In some embodiments, the external camera 250 is configured to generate RGB-D images in which each pixel has corresponding photometric information and geometric information (depth and/or distance). In such embodiments, the external camera 250 may, for example, take the form of two RGB cameras configured to capture stereoscopic images, from which depth and/or distance information can be derived, or an RGB camera with an associated IR camera configured to provide depth and/or distance information.

The IMU 252 is attached to the hand-held sports equipment 110 that is held by the athlete and is configured to measure inertial data as he or she engages in sports training using the AR sports training system 200. In some embodiments, the IMU 252 is configured to measure inertial data including one or more accelerations of the hand-held sports equipment 110. Particularly, the IMU 252 may be configured to measure linear accelerations of the head-mounted AR device 230 along one or more axes (e.g., roll, pitch, and yaw axes). In some embodiments, the IMU 252 is configured to measure inertial data including one or more rotational rates (or angular velocities) of the hand-held sports equipment 110. Particularly, the IMU 252 may be configured to measure rotational rates or angular velocities of the hand-held sports equipment 110 along one or more axes (e.g., roll, pitch, and yaw axes). In some embodiments, the IMU 252 is further configured to measure inertial data including one or more magnetic field strengths. Particularly, the IMU 252 may be configured to measure magnetic field strengths along one or more axes (e.g., roll, pitch, and yaw axes). Finally, in some embodiments, the IMU 252 is configured to measure inertial data including directly providing orientation data in the form of a time series of quaternions.

### Methods for Providing AR Visualizations and Feedback for Sports Training

A variety of methods, workflows, and processes are described below for enabling the operations and interactions of the AR sports training system 200. In these descriptions, statements that a method, workflow, processor, and/or system is performing some task or function refers to a controller or processor (e.g., the processor 212) executing programmed instructions (e.g., the AR sports training program 218, the AR graphics engine 220) stored in non-transitory computer-readable storage media (e.g., the memory 214) operatively connected to the controller or processor to manipulate data or to operate one or more components in the AR sports training system 200 to perform the task or function. Additionally, the steps of the methods may be performed in any feasible chronological order, regardless of the order shown in the figures or the order in which the steps are described.

Additionally, various AR graphical user interfaces are described for operating the AR sports training system 200. In many cases, the AR graphical user interfaces include graphical elements that are superimposed onto the user's view of the outside world or, in the case of a non-transparent display screen 232, superimposed on real-time images/video captured by the camera 234. To provide these AR graphical user interfaces, the processor 212 executes instructions of the AR graphics engine 220 to render these graphical elements and operates the display 28 to superimpose the graphical elements onto the user's view of the outside world or onto the real-time images/video of the outside world. In many cases, the graphical elements are rendered at a position that depends upon positional or orientation information received from any suitable combination of the sensors 236, the camera 234, the external camera 250, or the IMU 252 to simulate the presence of the graphical elements in a real-world environment. However, it will be appreciated by those of ordinary skill in the art that, in some cases, an equivalent non-AR graphical user interface can also be used to operate the AR sports training program 218, such as a user interface provided on a further computing device such as laptop computer, tablet computer, desktop computer, or a smartphone.

Moreover, various user interactions with the AR graphical user interfaces and with interactive graphical elements thereof are described. To provide these user interactions, the processor 212 may render interactive graphical elements in the AR graphical user interface, receive user inputs from, for example via gestures performed in view of one of the camera 234, the external camera 250, or other sensor, and execute instructions of the AR sports training program 218 to perform some operation in response to the user inputs.

Finally, various forms of motion tracking are described in which spatial positions and motions of the user or of objects in the environment are tracked. To provide this tracking of spatial positions and motions, the processor 212 executes instructions of the AR sports training program 218 to receive and process sensor data from any suitable combination of the sensors 236, the camera 234, the external camera 250, or the IMU 252, and may optionally utilize visual and/or visual-inertial odometry methods such as simultaneous localization and mapping (SLAM) techniques.

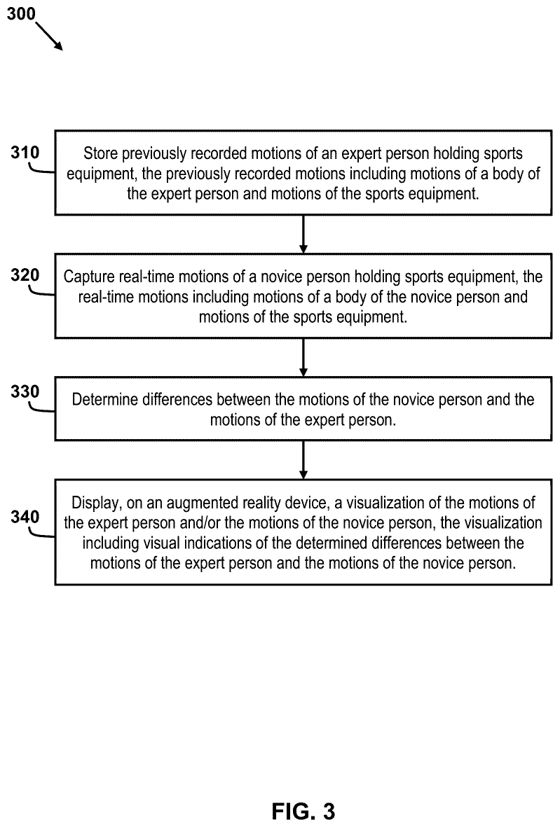

FIG. 3 shows a logical flow diagram for a method 300 for providing visual guidance for sports training. The method 300 advantageously captures and analyzes the real-time motions of a novice athlete and compares them with the previously recorded motions of an expert athlete. Additionally, the method 300 advantageously provides both embodied and detached visual guidance for the novice athlete and, in particular, provides feedback that helps the novice athlete to quickly and intuitively understand the differences between their real-time motions and the previously recorded motions of the expert athlete.

The method 300 begins with storing previously recorded motions of an expert person holding sports equipment, the previously recorded motions including motions of a body of the expert person and motions of the sports equipment (block 310). Particularly, the memory 214 stores, as a part of the AR sports training program 218, previously recorded motions of an expert athlete holding hand-held sports equipment. In some embodiments, the AR sports training program 218 includes a library of recorded motions of the expert athlete performing a variety of different activities associated with a sport in which the hand-held sports equipment is utilized. In the case of table tennis, the AR sports training program 218 might include previously recorded motions of the expert athlete for a variety of different stroke motions that are performed using a table tennis paddle while playing table tennis (e.g., a ‘Drive’ stroke, a ‘Loop’ stroke, or a ‘Push’ stroke).

The previously recorded motions of the expert athlete include both motions of the body of the expert athlete and motions of the hand-held sports equipment that was held by the expert athlete. Particularly, in some embodiments, the previously recorded motions of the expert athlete take the form of a sequence of human pose data and a sequence of object pose data. The sequence of human pose data is a time-series sequence of frames that each define positions and/or orientations of a plurality of joints of the expert athlete at a respective time. It should be appreciated that the collective positions of the plurality of joints define the pose of the expert athlete at each respective time and orientation data of each individual joint needn't necessarily be stored. Similarly, the sequence of object pose data is a time-series sequence of frames that each define a position and orientation of the hand-held sports equipment that was held by the expert athlete. In one embodiment, each frame in the sequence of object pose data includes a quaternion that represents the orientation of the hand-held sports equipment at the respective time. In some embodiments, the position of the hand-held sports equipment at the respective time is set to be fixed relative to or to be equal to a position of a particular joint (e.g., a hand-wrist joint) of the plurality of joints of the expert athlete. Thus, in some embodiments, the position of the hand-held sports equipment needn't necessarily be stored in the sequence of object pose data. In at least some embodiments, previously recorded motions of the expert athlete were recorded using a process similar to the process described below for capturing the real-time motions of a novice athlete holding hand-held sports equipment.

Prior to beginning sports training using the AR sports training program 218, a novice athlete wears the head-mounted AR device 230 on his or her head to access an AR graphical user interface provided by the head-mounted AR device 230. Initially, the AR sports training system 200 calibrates according to the novice athlete's height to adjust for the scale of the embodied and detached visualization guidance. Next, the novice athlete interacts with the AR graphical user interface to select a desired sports-related motion (e.g., a table tennis stroke) to practice.

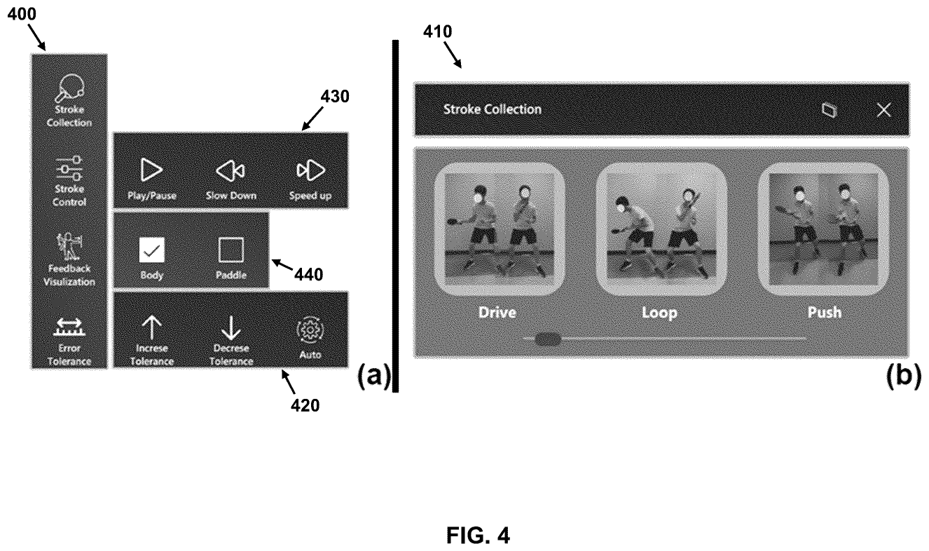

FIG. 4 shows exemplary AR graphical user interfaces of the AR sports training system 200. In illustration (a), a main menu 400 is shown. The novice athlete can click a “Stroke Collection” button located in the first row of the main menu 400. This action opens the stroke collection menu 410, shown in illustration (b), via which the novice athlete can begin sports training by choosing a pre-recorded motion from the library of motions provided by the AR sports training system 200. In the illustrated example, the novice athlete can select a ‘Drive’ stroke, a ‘Loop’ stroke, or a ‘Push’ stroke for table tennis practice.

The method 300 continues with capturing real-time motions of a novice person holding sports equipment, the real-time motions including motions of a body of the novice person and motions of the sports equipment (block 320). Particularly, after the user has selected a motion to be practiced, the processor 212 operates the external camera 250 and the IMU 252 to capture real-time motions of the novice athlete holding hand-held sports equipment. In particular, the processor 212 operates the external camera 250 to capture video of the real-time motions of the novice athlete holding hand-held sports equipment. Likewise, the processor 212 operates the IMU 252 to capture inertial data of the real-time motions of the novice athlete holding hand-held sports equipment. As mentioned above, the inertial data may include accelerations, rotational rates, magnetic field strengths, each along three dimensions, as well as quaternion orientation data. The combined data from the external camera 250 and the IMU 252 give the AR sports training system 200 a complete picture of how the novice athlete and hand-held sports equipment move. It should be appreciated that the hand-held sports equipment held by the novice athlete is of the same type as the hand-held sports equipment that was held by the expert athlete 100 during the recording of the previously recorded motions in the library of the AR sports training system 200.

As will be discussed in greater detail below, the real-time motions of the novice athlete holding hand-held sports equipment that are captured by the AR sports training system 200 are used to provide analysis and visual feedback on the performance of the novice athlete as he or she practices the motions that were previously selected in the AR graphical user interface. Concurrently with the capturing of real-time motions of the novice athlete holding hand-held sports equipment, the AR graphical user interface provides both embodied and detached visual guidance for the novice athlete and, in particular, provides feedback that helps the novice athlete to quickly and intuitively understand the differences between their real-time motions and the previously recorded motions of expert athlete 100.

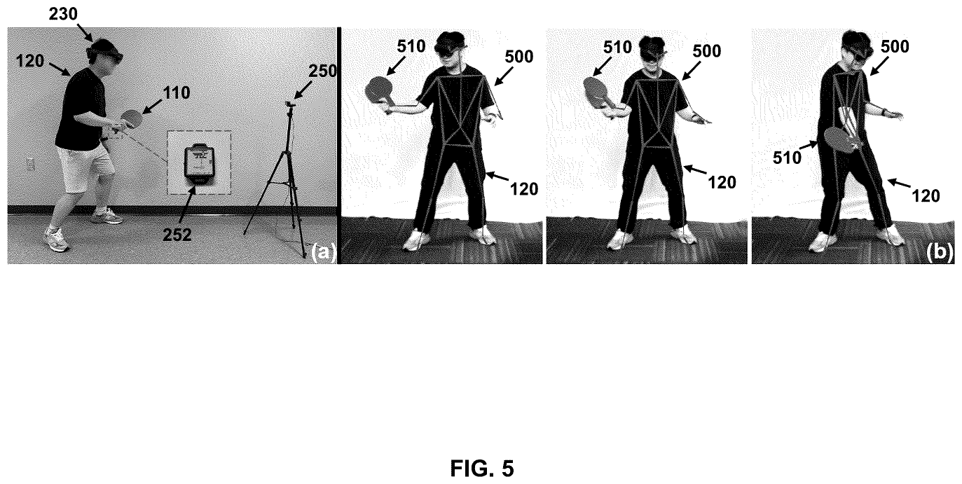

FIG. 5 shows a motion capture process of the motion capture module. The hardware setup enables capturing accurate and comprehensive motion capture data from the novice athlete 120. As shown in illustration (a), the external camera 250 is strategically positioned directly in front of the novice athlete 120. The external camera 250 serves as the primary visual input source, effectively capturing the actions and expressions of the novice athlete 120. The placement of the external camera 250 ensures an unobstructed view of the novice athlete 120, enabling the AR sports training system 200 to monitor their movements and reactions throughout the training. As shown in illustration (a), to further capture the information of the hand-held sports equipment 110 (e.g., a table tennis paddle), the AR sports training system 200 further includes the IMU 252 which provides precise tracking capabilities. The IMU 252 is seamlessly integrated at the bottom of the hand-held sports equipment 110 (e.g., near the handle of the table tennis paddle), allowing the AR sports training system 200 to record and analyze the pose of the hand-held sports equipment 110 in real-time. Thus, the external camera 250 provides the visual input for the AR sports training system 200 and the IMU 252 provides the orientation of the hand-held sports equipment 110. The combination of the external camera 250 and the IMU 252 creates a comprehensive and multi-dimensional dataset that forms the foundation of the motion analysis. This rich data stream enables the AR sports training system 200 to quantify the performance of the novice athlete 120. It should be appreciated that a wide variety of sensing techniques may be adopted for the purpose of human body tracking and hand-held sports equipment tracking. For example, a vision-based object tracking algorithm may be used for tracking the paddle, rather than a discrete IMU. Examples of motion capture results with different body and paddle postures are shown in illustration (b) of FIG. 5. Particularly, for illustrative purposes, the real-time motion tracking of the novice athlete 120 is shown as a virtual avatar 500 and virtual sports equipment 510 overlaid upon the novice athlete 120.

The real-time motions of the novice athlete include both motions of the body of the novice athlete and motions of the hand-held sports equipment that is held by the novice athlete. Particularly, in some embodiments, the real-time motions of the novice athlete take the form of a sequence of human pose data and a sequence of object pose data. In at least some embodiments, the processor 212 determines the sequence of human pose data based on the video captured by the external camera 250 using a vision-based human pose estimation algorithm or pose tracking algorithm. Particularly, based on the video, the processor 212 determines the positions and/or orientations of the plurality of joints of the novice athlete and outputs frames in the sequence of human pose data in real-time. The sequence of human pose data is a time-series sequence of frames that each define positions and/or orientations of a plurality of joints of the novice athlete at a respective time. It should be appreciated that the collective positions of the plurality of joints define the pose of the novice athlete at each respective time and orientation data of each individual joint needn't necessarily be calculated.

In contrast, in at least some embodiments, the processor 212 determines the sequence of object pose data based on the video captured by the external camera 250 and the inertial data captured by the IMU 252. The sequence of object pose data is a time-series sequence of frames that each define a position and orientation of the hand-held sports equipment that is held by the novice athlete. In some embodiments, the processor 212 calculates the sequence of object pose data as a time series of quaternions. Thus, each frame in the sequence of object pose data includes a quaternion that represents the orientation of the hand-held sports equipment at a respective time. As noted previously, in some embodiments, the quaternions may be provided directly by the IMU 252, but may also be calculated from other inertial data or from the video data.

In some embodiments, the processor 212 calculates the orientation of the hand-held sports equipment for each frame in the sequence of object pose data based on the inertial data captured by the IMU 252, but calculates the position of the hand-held sports equipment for each frame in the sequence of object pose data based on the video data. Particularly, in one embodiment, the processor 212 sets the position of the hand-held sports equipment to be fixed relative to or to be equal to a position of a particular joint (e.g., a hand-wrist joint) of the plurality of joints of the novice athlete. In this way, the position of the hand-held sports equipment is properly aligned with the sequence of human pose data. Thus, in some embodiments, the position of the hand-held sports equipment needn't necessarily be provided in the sequence of object pose data at all.

In some embodiments, which lack the IMU 252, the processor 212 determines the sequence of object pose data based only on the video captured by the external camera 250 using a vision-based object pose estimation algorithm or pose tracking algorithm.

With reference again to FIG. 3, the method 300 continues with determining differences between the motions of the novice person and the motions of the expert person (block 330). Particularly, the processor 212 determines differences between the real-time motions of the novice athlete and the previously recorded motions of the expert athlete. More particularly, the processor 212 determines both (i) differences between the real-time motions of the body of the novice athlete and the previously recorded motions of the body of the expert athlete and (ii) differences between the real-time motions of the hand-held sports equipment and the previously recorded motions of the hand-held sports equipment. In some embodiments, the determined differences are in the form of error scores or error values. In at some embodiments, the processor 212 determines the differences with respect to motions of the body of the novice athlete on a joint-by-joint basis and on a frame-by-frame basis. In at some embodiments, the processor 212 determines the differences with respect to the motions of the hand-held sports equipment on a frame-by-frame basis.

Based on the determined differences, the processor 212 determines whether the real-time motions of the novice athlete are performed incorrectly. In particular, the processor 212 compares the determined differences with one or more thresholds. If a determined difference is greater than a respective threshold, then the processor 212 determines that a corresponding portion of the real-time motions are performed incorrectly. In some embodiments, the processor 212 determines, based on the determined differences, that one or more particular joints of the novice athlete were incorrectly positioned during the real-time motions of the novice athlete during a particular time interval. In some embodiments, the processor 212 determines, based on the determined differences, that the hand-held sports equipment held by the novice athlete was incorrectly positioned or oriented during the real-time motions of the novice athlete during a particular time interval.

In some embodiments, for the purpose of comparing the real-time motions of the body of the novice athlete and the previously recorded motions of the body of the expert athlete, the AR sports training system 200 utilizes joint angle quaternions when analyzing body movements and uses dynamic time warping to correctly compare between the body movements of the novice athlete and the body movements of the expert athlete.

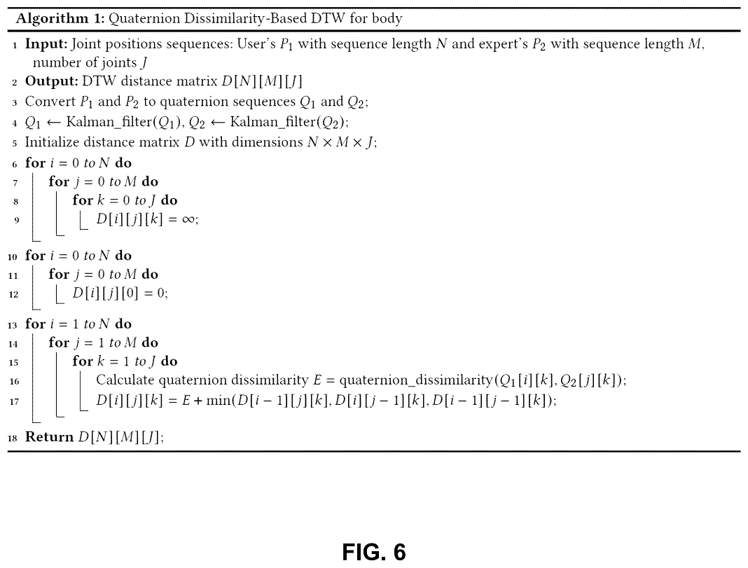

FIG. 6 shows pseudocode for an Algorithm 1 that compares the body movements of the novice athlete and the body movements of the expert athlete. First, the processor 212 receives the sequence of human pose data defining the real-time motions of the body of the novice athlete, denoted P₁ ∈R^{N×J}^{ₐₗₗ}^{×3}, and the sequence of human pose data defining the previously recorded motions of the body of the expert athlete, denoted P₂ ∈R^{M×J}^{ₐₗₗ}^{×3} (line 1 of Algorithm 1). Here, N denotes the number of frames in the sequence of human pose data defining the real-time motions of the body of the novice athlete, M denotes the number of frames in the sequence of human pose data defining the previously recorded motions of the body of the expert athlete, Jₐₗₗ denotes the number of all joints, and 3 denotes the three-dimensional joint positions. In one embodiment, the processor 212 considers all joints except the end joints, such as the head, toes, and thumbs. This subset of joints is denoted J. In such cases, P₁ ∈R^{N×J×3} and P₂ ∈R^{M×J×3}.

Next, the processor 212 calculates a sequence of joint angle quaternions vectors, denoted Q₁ ∈R^{N×J×4}, for the novice athlete based on the sequence P₁ (line 4 of Algorithm 1). Likewise, in one embodiment, the processor 212 calculates a sequence of joint angle quaternions vectors, denoted Q₂ ∈R^{M×J×4}, for the expert athlete based on the sequence P₂ (line 3 of Algorithm 1). These quaternions vectors represent the rotations required to transform a vertex v₁ into a vertex v₂. In some embodiments, the processor filters the sequences Q₁ and Q₂ using a Kalman filter (line 4 of Algorithm 1).

Next, the processor 212 uses this joint angle data to perform a comparative analysis between the real-time motions of the body of the novice athlete and the previously recorded motions of the body of the expert athlete. Particularly, the processor 212 initializes and calculates a DTW distance matrix D, having dimensions N×M×J. The DTW distance matrix D consists of error values that represent differences for each joint, in each frame of the sequence Q₁ compared with each frame of the sequence Q₂. A lower error value indicates a better performance by the novice athlete. In some embodiments, since the novice athlete may act slightly faster or slower than the expert athlete, for real-time comparison, the processor 212 uses, for example, N=M=10 to reduce the computation cost, otherwise, N and M refer to the length of the sequence.

To calculate the DTW distance matrix D, the processor 212 determines quaternion dissimilarities between each joint in each frame of the sequence Q₁ and each joint in each frame of the sequence Q₂ (line 16 of Algorithm 1). The processor 212 calculates each quaternion dissimilarity using the quaternions dissimilarity equation:

$${quaternion}_{-} dissimilarity ( {q}_{1} , {q}_{2} ) = \frac{{q}_{1} \cdot {q}_{2}}{‖ {q}_{1} ‖ ‖ {q}_{2} ‖}$$

where q₁, q₂ represent two quaternions vectors. Next, the processor 212 determines the error values in the DTW distance matrix D by aligning the sequence Q₂ with the sequence Q₁ based on the quaternion dissimilarities and using dynamic time warping (line 17 of Algorithm 1).

Based on the DTW distance matrix D, the processor 212 determines whether the real-time motions of the novice athlete are performed incorrectly. In particular, the processor 212 determines, based on the determined differences, that one or more particular joints of the novice athlete were incorrectly positioned during the real-time motions of the novice athlete during a particular time interval. To this end, the processor 212 compares the error values of the DTW distance matrix D with a universal threshold ξⱼₒᵢₙₜ. If a determined difference is greater than a respective threshold, then the processor 212 determines that a corresponding joint is positioned incorrectly during the real-time motions. In some embodiments, the novice athlete's movement is considered incorrect if:

D[N][M][k]/N<1−ξⱼₒᵢₙₜ

Similarly, for the purpose of comparing the real-time motions of the hand-held sports equipment held by the novice athlete and the previously recorded motions of the hand-held sports equipment held by the expert athlete, the AR sports training system 200 also uses a quaternion-dissimilarity based dynamic time warping.

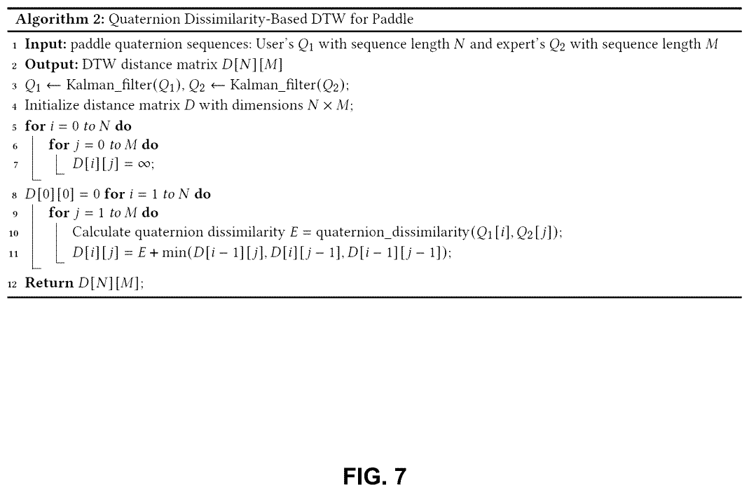

FIG. 7 shows pseudocode for an Algorithm 2 that compares the movements of hand-held sports equipment held by the novice athlete and the movements of hand-held sports equipment held by the expert athlete. First, the processor 212 receives a sequence of quaternions vectors, denoted Q₁ ∈R^{N×4}, representing the real-time motions of the hand-held sports equipment held by the novice athlete and sequence of quaternions vectors, denoted Q₂ ∈R^{M×4}, representing the real-time motions of the hand-held sports equipment held by the novice athlete (line 1 of Algorithm 2). In some embodiments, the processor filters the sequences Q₁ and Q₂ using a Kalman filter (line 3 of Algorithm 2). In some embodiments, the sequences Q₁ and Q₂ are provided directly by the IMU 252. However, in cases in which the IMU 252 does not provide quaternion vectors, the processor 212 calculates the quaternions from the inertial data that are provided by the IMU 252.

Next, the processor 212 uses the sequences Q₁ and Q₂ to perform a comparative analysis between the real-time motions of the hand-held sports equipment held by the novice athlete and the previously recorded motions of the hand-held sports equipment held by the expert athlete. Particularly, the processor 212 initializes and calculates a DTW distance matrix D, having dimensions N×M. The DTW distance matrix D consists of error values that represent differences for each frame of the sequence Q₁ compared with each frame of the sequence Q₂. A lower error value indicates a better performance by the novice athlete. In some embodiments, since the novice athlete may act slightly faster or slower than the expert athlete, for real-time comparison, the processor uses, for example, N=M=10 to reduce the computation cost, otherwise, N and M refer to the length of the sequence.

To calculate the DTW distance matrix D, the processor 212 determines quaternion dissimilarities between each frame of the sequence Q₁ and each frame of the sequence Q₂ (line 10 of Algorithm 2). Next, the processor 212 determines the error values in the DTW distance matrix D by aligning the sequence Q₂ with the sequence Q₁ based on the quaternion dissimilarities and using dynamic time warping (line 11 of Algorithm 2).

In some embodiments, the processor 212 determines, based on the determined differences, that the hand-held sports equipment held by the novice athlete was incorrectly positioned or oriented during the real-time motions of the novice athlete during a particular time interval.

Based on the DTW distance matrix D, the processor 212 determines whether the real-time motions of the novice athlete are performed incorrectly. In particular, the processor 212 determines, based on the determined differences, that the hand-held sports equipment held by the novice athlete was incorrectly positioned or oriented during a particular time interval. To this end, the processor 212 compares the error values of the DTW distance matrix D with a universal threshold ξ_{paddle}. If a determined difference is greater than a respective threshold, then the processor 212 determines that the hand-held sports equipment held by the novice athlete was incorrectly positioned or oriented during the real-time motions during a particular time interval. In some embodiments, the novice athlete's movement is considered incorrect if:

D[N][M]/N<1−ξ_{paddle}

With reference again to FIG. 4, the AR graphical user interface includes an “Error Tolerance” button located in the bottom row of the main menu 400. The novice athlete can click the “Error Tolerance” button to open an error tolerance submenu 420, shown in illustration (a), via which the novice athlete can manually increase or decrease the universal threshold values ξⱼₒᵢₙₜ and ξ_{paddle}, or opt for adaptive/automatic values for the universal threshold values ξⱼₒᵢₙₜ and ξ_{paddle}. Particularly, in response to user inputs received via the error tolerance submenu 420, the processor 212 adjusts a value of one or both of the universal threshold values ξⱼₒᵢₙₜ and ξ_{paddle}. In one embodiment, ξⱼₒᵢₙₜ=ξ_{paddle}=0.1 are empirically set during initialization of the AR sports training system 200.

With reference again to FIG. 3, the method 300 continues with displaying, on an augmented reality device, a visualization of the motions of the expert person and/or the motions of the novice person, the visualization including visual indications of the determined differences between the motions of the expert person and the motions of the novice person (block 340). Particularly, after the novice athlete selects a sports-related motion for practice, the processor 212 operates the display screen 232 of the head-mounted AR device 230 to display an AR graphical user interface. The AR graphical user interface includes one or more visualizations of the previously recorded motions of the expert athlete and the real-time motions of the novice athlete. The visualizations include visual indications of the determined differences between the real-time motions of the novice athlete and the previously recorded motions of the expert athlete. These visualizations serve as visual cues that enable the novice athlete to better visualize and correct errors in their real-time motions relative to those of the expert athlete, thereby acquiring proficiency in performing the motions.

In some embodiments, the AR graphical user interface of the AR sports training system 200 employs two distinct types of visualizations to enhance the learning experience and provide valuable guidance during sports training. First, the AR graphical user interface incorporates detached visualizations that are superimposed on the environment around the novice athlete. Second, the AR graphical user interface incorporates embodied visualizations that are superimposed on the body of the novice athlete. In at least some embodiments, the visualizations include skeleton-like or otherwise human-like virtual avatars. In some embodiments, the virtual avatars are animated based on the real-time motions of the novice athlete or the previously recorded motions of the expert athlete.

As discussed above, during sports training, the AR sports training system 200 compares the real-time motions of the novice athlete with the previously recorded ‘ideal’ or ‘correct’ motions of the expert athlete. Based on determined differences, the skeleton-like virtual avatars incorporate visual indications, such as highlighting, that convey to the novice athlete any deviations (differences) between their real-time motions and the previously recorded ‘correct’ motions of the expert athlete.

By incorporating both detached and embodied visual cues, the AR sports training system 200 provides a comprehensive and immersive training environment. Novice athletes can learn from expert athletes, compare their movements, and receive targeted guidance, all of which contribute to an effective and engaging learning experience. These visual cues are integral to helping novice athletes master complex movements and improve their skills in real-time.

Referring back to FIG. 4, after the novice athlete interacts with stroke collection menu 410 to select a motion, the processor 212 operates the display screen 232 to begin displaying a visualization of the previously recorded motions of the expert athlete so that the novice athlete can begin practicing the motions. In some embodiments, the visualization takes the form of a virtual human avatar, referred to herein as the expert avatar, that holds virtual sports equipment and is animated according to the previously recorded motions of the expert athlete. The expert avatar is superimposed on an environment in front of the novice athlete. FIG. 1C shows one exemplary embodiment in which an expert avatar 140 takes the form of a human skeleton-like visualization. The expert avatar 140 is continuously animated (e.g., in a playback loop) according to the previously recorded motions of the expert athlete.

Additionally, as the novice athlete performs motions in real-time, i.e., to practice the sports-related motion, the AR sports training system 200 captures and analyzes the real-time motions of the novice athlete. The processor 212 operates the display screen 232 to also display a visualization of the real-time motions of the novice athlete. In some embodiments, the visualization takes the form of another virtual human avatar, referred to herein as the novice avatar or user avatar, that holds virtual sports equipment and is animated according to the real-time motions of the novice athlete. The novice avatar is superimposed on an environment in front of the novice athlete (e.g., next to the expert avatar). FIG. 1C shows one exemplary embodiment in which a novice avatar 150 takes the form of a human skeleton-like visualization. The novice avatar 150 is animated synchronously with the real-time motions of the novice athlete. Thus, the novice avatar 150 reflects both the real-time pose of the novice athlete's body and the real-time pose of the hand-held sports equipment (e.g., a table tennis paddle).

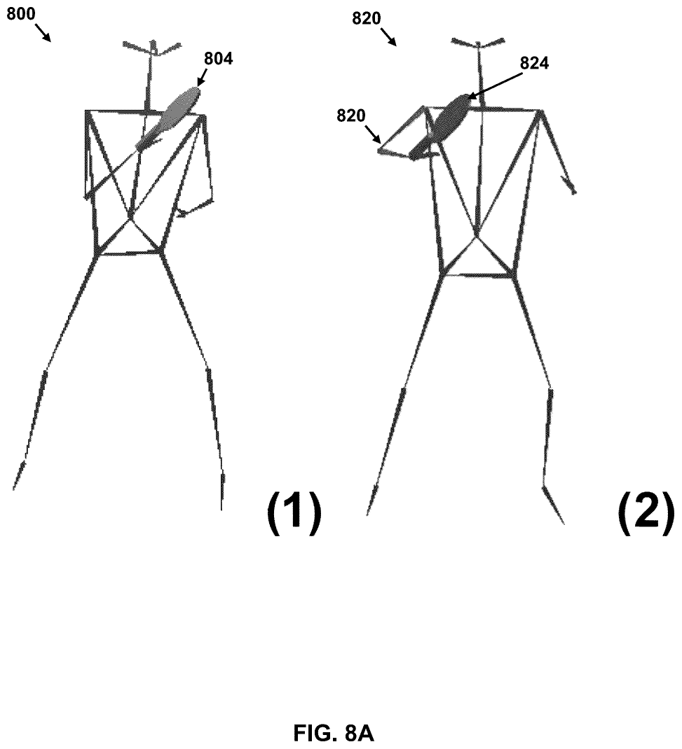

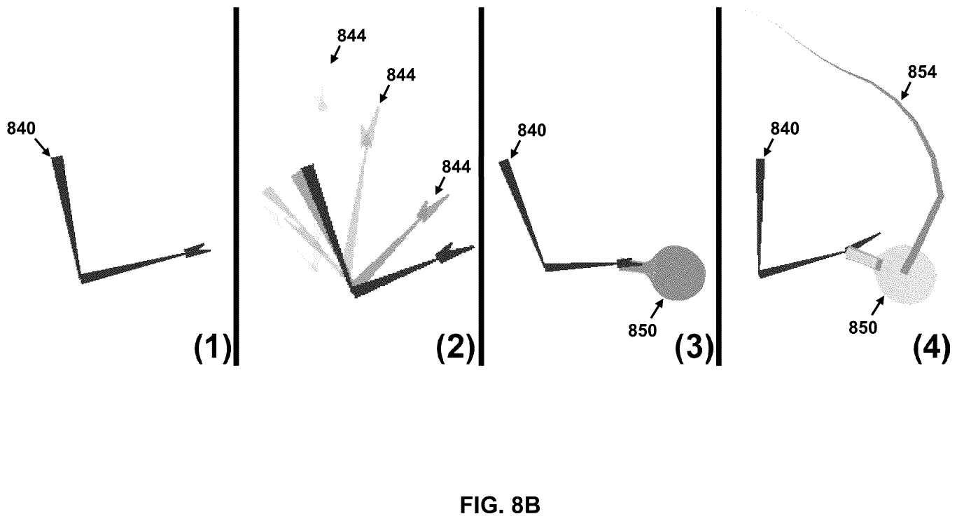

FIG. 8A shows exemplary detached virtual avatars for table tennis sports training. Particularly, in illustration (1) on the left, an expert avatar 800 is shown. The expert avatar 800 is in the form of a skeleton having a plurality of joints (vertices) connected by bones (edges) and holds a virtual table tennis paddle 804. The joints of the expert avatar 800 are positioned and animated according to the joints in the sequence of human pose data captured based on the previously recorded motions of the expert athlete. Similarly, in illustration (2) on the right, a novice avatar 820 is shown. The novice avatar 820 is in the form of a skeleton having a plurality of joints (vertices) connected by bones (edges) and holds a virtual table tennis paddle 824. The joints of the novice avatar 820 are positioned and animated according to the joints in the sequence of human pose data captured based on the real-time motions of the novice athlete. These visual cues serve as a reference point for novice athletes to understand and replicate specific movements accurately. The expert avatar 800 serves as a visual representation of the ideal trajectory of movement. It reflects the precise stroke movements recorded by experts. Novice athletes can observe how experts perform various actions and aim to replicate those movements. Conversely, the novice avatar 820 reflects the movements of the novice athlete in real-time. As novice athletes engage with the AR sports training system 200, the novice avatar 820 mirrors their actions, allowing them to see how closely their movements align with the expert's actions. In one embodiment, the detached expert avatar and novice avatar are superimposed at a predetermined distance (e.g., 3 meters) in front of the novice athlete, and the scales of the detached cues are changeable during use, allowing for flexibility in the visual representation.

In at least some embodiments, the novice avatar is rendered to include visual indications of the determined differences between the real-time motions of the novice athlete and the previously recorded motions of the expert athlete. In particular, in one embodiment, based on the DTW distance matrix D representing differences in the sequences of human pose data P₁ and P₂, the processor 212 identifies particular joints or particular portions of the body that are incorrectly positioned during the real-time motions of the novice athlete during a particular time interval, e.g., by comparing the values in the DTW distance matrix D with the universal threshold ξⱼₒᵢₙₜ. In response to determining that particular joints or particular portions of the body are incorrectly positioned during the real-time motions, the processor 212 renders the novice avatar to include a visual indication of particular joints or particular portions of the body that are incorrectly positioned. With reference again to FIG. 8A, the novice avatar 820 includes an arm that is highlighted in a different color (e.g., pink) than the rest of the novice avatar 820 (or otherwise highlighted in some way) to indicate that the arm and/or the elbow joint is or was incorrectly positioned by the novice athlete.

Similarly, in one embodiment, based on the DTW distance matrix D representing differences in the sequences of object pose data P₁ and P₂, the processor 212 identifies whether the hand-held sports equipment held by the novice athlete is incorrectly positioned or oriented during the real-time motions of the novice athlete during a particular time interval, e.g., by comparing the values in the DTW distance matrix D with the universal threshold ξ_{paddle}. In response to determining that the hand-held sports equipment held by the novice athlete is incorrectly positioned or oriented during the real-time motions, the processor 212 renders the virtual sports equipment held by the novice avatar to include a visual indication that the hand-held sports equipment held by the novice athlete is incorrectly positioned or oriented. In one example (not shown), the virtual sports equipment (e.g., the virtual table tennis paddle 824) is highlighted in a different color (e.g., pink) than the rest of the novice avatar 820 (or otherwise highlighted in some way) to indicate that the hand-held sports equipment is or was incorrectly positioned or oriented by the novice athlete.

This immediate feedback empowers novice athletes to make real-time adjustments and improvements to their performance. By providing both the expert avatar and the novice avatar, the AR sports training system 200 enables novice athletes to visually compare their movements with those of experts, fostering a deeper understanding of the desired actions and encouraging continuous improvement.

In addition to the expert avatar and the novice avatar, which are superimposed on the environment in a detached manner, the AR sports training system 200 also provides embodied visualizations that are superimposed on the body of the novice athlete. Particularly, the processor 212 operates the display screen 232 to display an embodied visualization of the previously recorded motions of the expert athlete. Embodied visualizations take the form of guidance provided directly within the user's field of view and superimposed upon their body, offering real-time feedback and assistance when needed. These visual cues are particularly valuable for refining specific aspects of movement. During training, the AR sports training system 200 overlays the correct movement trajectories onto the novice athlete's body.

In some embodiments, the embodied visualizations are dynamic and context-sensitive, appearing only when novice athletes make incorrect movements. Particularly, in response to determining that particular joints or particular portions of the body are incorrectly positioned during the real-time motions, the processor 212 operates the display screen 232 to display an embodied visualization of the previously recorded motions of the expert athlete. Likewise, in response to determining that the hand-held sports equipment held by the novice athlete is incorrectly positioned or oriented during the real-time motions, the processor 212 operates the display screen 232 to display an embodied visualization of the previously recorded motions of the expert athlete.

In some embodiments, the visualization takes the form of a virtual avatar, referred to herein as the embodied avatar, that holds virtual sports equipment and is animated according to the previously recorded motions of the expert athlete. Unlike the expert avatar, the embodied avatar is superimposed upon the body of the novice athlete. FIG. 1C shows one exemplary embodiment in which an embodied avatar 160 takes the form of a human skeleton-like visualization, which includes an embodied virtual arm 164 holding virtual sports equipment 170. The embodied avatar 160 is superimposed on the body of the novice athlete, to the extent that the body of the novice athlete is within the field of view of the head-mounted AR device 230. The embodied avatar 160 is continuously animated (e.g., in a playback loop) according to the previously recorded motions of the expert athlete. In one embodiment, the embodied avatar is attached to the user based on their starting position, and the scale of the embodied avatar is adapted based on the height of the novice athlete.

In some embodiments, the embodied avatar is rendered to include visual indications of the determined differences between the real-time motions of the novice athlete and the previously recorded motions of the expert athlete, in a similar manner that was discussed with respect to the novice avatar. In response to determining that particular joints or particular portions of the body are incorrectly positioned during the real-time motions, the processor 212 renders the embodied avatar to include a visual indication of particular joints or particular portions of the body that are incorrectly positioned. Likewise, in response to determining that the hand-held sports equipment held by the novice athlete is incorrectly positioned or oriented during the real-time motions, the processor 212 renders the virtual sports equipment held by the embodied avatar to include a visual indication that the hand-held sports equipment held by the novice athlete is incorrectly positioned or oriented.

Additionally, in some embodiments, the embodied avatar is rendered to include visual indications of correct motion trajectories. Particularly, in one embodiment, the processor 212 renders the embodied virtual arm of the embodied avatar to include visual indications of a motion trajectory of an arm of the expert athlete in the previously recorded motions of the expert athlete. Similarly, in one embodiment, the processor 212 renders the virtual sports equipment of the embodied avatar to include visual indications of a motion trajectory of the hand-held sports equipment held by the expert athlete in the previously recorded motions of the expert athlete.

FIG. 8B shows exemplary embodied virtual avatars for table tennis sports training. Particularly, in illustrations (1) and (2) on the left, an embodied virtual arm 840 is shown. The embodied virtual arm 840 is in the form of a skeletal arm having joints (vertices) connected by bones (edges), and holds a virtual table tennis paddle 850, as shown in illustrations (3) and (4) on the right. The joints of the embodied virtual arm 840 are positioned and animated according to the joints in the sequence of human pose data captured based on the previously recorded motions of the expert athlete. However, unlike the expert avatar 800, the embodied virtual arm 840 is superimposed on the body of the novice athlete and, more particularly, is superimposed on the arm of the novice athlete. As the embodied virtual arm 840 is animated, the embodied virtual arm 840 is rendered with a sequence of ghosts 844 that indicate a motion trajectory of the embodied virtual arm 840. Each of the ghosts 844 has a form that is similar to that of the embodied virtual arm 840 but is positioned and oriented according to a prior-in-time pose of the embodied virtual arm 840, thereby indicating a motion trajectory of the embodied virtual arm 840. In some embodiments, the ghosts 844 are progressively more transparent and eventually fade away after a particular amount of time. Additionally, the embodied virtual arm 840 is animated, and the virtual table tennis paddle 850 is rendered with a motion trail 854 that indicates a motion trajectory of the virtual table tennis paddle 850. In some embodiments, the motion trail 854 is progressively thinner and eventually fades away after a particular amount of time or a particular distance from the current position of the virtual table tennis paddle 850. These visual aids help novice athletes understand the precise path their joints should follow to match the expert athlete's movements. Novice athletes can use this information to adjust their movements for greater accuracy.

In at least some embodiments, during training, novice athletes have the flexibility to manipulate the position, viewpoint, and scale of both the novice avatar and the expert avatar. Furthermore, novice athletes can pause, resume, and adjust the playback speed of the expert avatar and the embodied avatar, allowing for a detailed slow-motion examination of the stroke. All of these interactions are seamlessly facilitated through our user-friendly interface. For both the expert avatar and the novice avatar, novice athletes have the capability to adjust the avatar's scale through gestures. Additionally, novice athletes can customize the feedback provided by the AR sports training system 200 by enabling or disabling body and paddle feedback.

With reference again to FIG. 4, the exemplary AR graphical user interfaces include a “Stroke Control” button located in the second row of the main menu 400. The novice athlete can click the “Stroke Control” button to open a stroke control submenu 430, shown in illustration (a), via which the novice athlete can pause and play the animations of the expert avatar and/or of the embodied avatar, as well as manually slow down and speed up the playback of the animations. Particularly, in response to user inputs received via the stroke control submenu 430, the processor 212 adjusts the animation speed of the expert avatar and/or of the embodied avatar within the AR graphical user interfaces during sports training. In addition, the exemplary AR graphical user interfaces include a “Feedback Visualization” button located in the third row of the main menu 400. The novice athlete can click the “Feedback Visualization” button to open a feedback visualization submenu 440, shown in illustration (a), via which the novice athlete can enable or disable the virtual sports equipment or the virtual avatars of the visualizations. Particularly, in response to user inputs received via the feedback visualization submenu 440, the processor 212 hides or shows the virtual sports equipment and/or one or more of the virtual avatars within the AR graphical user interfaces during sports training.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general-purpose or special-purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data that cause a general-purpose computer, special-purpose computer, or special-purpose processing device to perform a certain function or group of functions. Computer-executable instructions also include program modules that are executed by computers in stand-alone or network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered illustrative and not restrictive in character. It is understood that only the preferred embodiments have been presented and that all changes, modifications, and further applications that come within the spirit of the disclosure are desired to be protected.

What is claimed is:

1. A method for providing visual guidance for sports training, the method comprising:
storing, in a memory, previously recorded motions of a first person holding first hand-held sports equipment, the previously recorded motions including motions of a body of the first person and motions of the first hand-held sports equipment;
capturing, with at least one sensor, real-time motions of a second person holding second hand-held sports equipment, the second hand-held sports equipment being of a same type as the first hand-held sports equipment, the real-time motions including motions of a body of the second person and motions of the second hand-held sports equipment;
determining, with a processor, differences between the real-time motions of the second person and the previously recorded motions of the first person; and
displaying, on a display of an augmented reality device, a visualization of at least one of (i) the previously recorded motions of the first person and (ii) the real-time motions of the second person, the visualization including visual indications of the determined differences between the real-time motions of the second person and the previously recorded motions of the first person.

2. The method according to claim 1, the capturing the real-time motions further comprising:
determining a second sequence of human pose data having frames that each define positions of a second plurality of joints of the second person at a respective time; and
determining a second sequence of object pose data having frames that each define a pose of the second hand-held sports equipment at a respective time.

3. The method according to claim 2, the capturing the real-time motions further comprising:
capturing video of the real-time motions of the second person holding the second hand-held sports equipment using a camera arranged externally to the augmented reality device; and
determining, based on the video, the second sequence of human pose data using a human pose estimation algorithm.

4. The method according to claim 3, the capturing the real-time motions further comprising:
capturing inertial data of the motions of the second hand-held sports equipment using an inertial measurement unit arranged on the second hand-held sports equipment; and
determining, based on the inertial data and the video, the second sequence of object pose data.

5. The method according to claim 4, the capturing the real-time motions further comprising:
determining, based on the video, a respective position of the second hand-held sports equipment for each frame in the second sequence of object pose data; and
determining, based on the inertial data, an orientation of the second hand-held sports equipment for each frame in the second sequence of object pose data.

6. The method according to claim 1, the determining the differences further comprising:
determining first differences between the motions of the body of the second person and the motions of the body of the first person; and
determining second differences between the motions of the second hand-held sports equipment and the motions of the first hand-held sports equipment.

7. The method according to claim 1, wherein (i) the previously recorded motions include a first sequence of human pose data having frames that each define positions of a first plurality of joints of the first person at a respective time and (ii) the real-time motions include a second sequence of human pose data having frames that each define positions of a second plurality of joints of the second person at a respective time, the determining first differences further comprising:
calculating a first sequence of joint angle quaternion vectors based on the first sequence of human pose data;
calculating a second sequence of joint angle quaternion vectors based on the second sequence of human pose data; and
determining the first differences by (i) determining quaternion dissimilarities between the second sequence of joint angle quaternion vectors and the first sequence of joint angle quaternion vectors and (ii) aligning the second sequence of joint angle quaternion vectors with the first sequence of joint angle quaternion vectors, based on the quaternion dissimilarities using dynamic time warping.

8. The method according to claim 1, wherein (i) the previously recorded motions include a first sequence of object pose data having frames that each define a quaternion of the first hand-held sports equipment at a respective time and (ii) the real-time motions include a second sequence of object pose data having frames that each define a quaternion of the second hand-held sports equipment at a respective time, the determining second differences further comprising:
determining the second differences by (i) determining quaternion dissimilarities between the second sequence of object pose data and the first sequence of object pose data and (ii) aligning the second sequence of object pose data with the first sequence of object pose data, based on the quaternion dissimilarities using dynamic time warping.

9. The method according to claim 1, the displaying the visualization further comprising:
displaying a first virtual human avatar holding virtual sports equipment that is animated according to the previously recorded motions of the first person, the first virtual human avatar being superimposed on an environment in front of the second person.

10. The method according to claim 9, the displaying the visualization further comprising:
adjusting, based on a user input received from the second person, an animation speed of the first virtual human avatar.

11. The method according to claim 1, the displaying the visualization further comprising:
displaying a second virtual human avatar holding virtual sports equipment that is animated according to the real-time motions of the second person, the second virtual human avatar being superimposed on an environment in front of the second person.

12. The method according to claim 11, the displaying the second virtual human avatar further comprising:
determining, based on the determined differences, at least one joint of the second person that is incorrectly positioned during the real-time motions of the second person; and
displaying the second virtual human avatar including a visual indication of the at least one joint that is incorrectly positioned during the real-time motions of the second person.

13. The method according to claim 12, determining the at least one joint of the second person that is incorrectly positioned further comprising:
comparing the determined differences with at least one threshold; and
adjusting the at least one threshold based on a user input received from the second person.

14. The method according to claim 11, the displaying the second virtual human avatar further comprising:
determining, based on the determined differences, that the second hand-held sports equipment held by the second person is incorrectly positioned or oriented during the real-time motions of the second person; and
displaying the second virtual human avatar including a visual indication that the second hand-held sports equipment is incorrectly positioned or oriented during the real-time motions of the second person.

15. The method according to claim 1, the displaying the visualization further comprising:
displaying a virtual arm holding virtual sports equipment that is animated according to the previously recorded motions of the first person, the virtual arm being superimposed upon an arm of the second person.

16. The method according to claim 15, the displaying the virtual arm further comprising:
determining, based on the determined differences, that the second person has performed an incorrect motion during the real-time motions; and
displaying the virtual arm holding virtual sports equipment in response to determining that the second person has performed an incorrect motion.

17. The method according to claim 15, the displaying the virtual arm further comprising:
displaying the virtual arm including a visual indication of a motion trajectory of an arm of the first person in the previously recorded motions of the first person.

18. The method according to claim 15, the displaying the virtual arm further comprising:
displaying the virtual sports equipment including a visual indication of a motion trajectory of the first hand-held sports equipment held by the first person in the previously recorded motions of the first person.

19. The method according to claim 15, the displaying the virtual arm further comprising:
determining, based on the determined differences, at least one joint of the arm of the second person that is incorrectly positioned during the real-time motions of the second person; and
displaying the virtual arm including a visual indication of the at least one joint that is incorrectly positioned during the real-time motions of the second person.

20. The method according to claim 15, the displaying the virtual arm further comprising:
determining, based on the determined differences, that the second hand-held sports equipment held by the second person is incorrectly positioned or oriented during the real-time motions of the second person; and
displaying the virtual sports equipment held by the virtual arm including a visual indication that the second hand-held sports equipment is incorrectly positioned or oriented during the real-time motions of the second person.
